(19) United States
(12) Patent Application Publication
(10) Pub. No.: US 2018/0359448 A1
(43) Pub. Date: Dec. 13, 2018

(54) MULTIPARTY COLLABORATIVE INTERACTION IN A VIRTUAL REALITY ENVIRONMENT

(71) Applicant: DIGITAL MYTHS STUDIO, INC., Fremont, CA (US)

(72) Inventor: John William HARRIES, Fremont, CA (US)

(21) Appl. No.: 16/001,269

(22) Filed: Jun. 6, 2018

Related U.S. Application Data
(60) Provisional application No. 62/516,573, filed on Jun. 7, 2017.

(51) Int. Cl. H04N 7/15; G06F 3/0481; G06F 3/01; G06T 19/20; G02B 27/01

(52) U.S. Cl. CPC H04N 7/157; G06F 3/04815; G02B 27/017; G06T 19/20; G06F 3/011

(57) ABSTRACT

This disclosure describes systems and methods for true interaction between a plurality of users (e.g., and their respective avatars) in real-time within a virtual reality environment. The disclosed system can provide virtual, physicalized objects (e.g., virtual object representations) that can be handed around among users (avatars), jointly lifted, carried and placed, while maintaining a smooth continuity of experience and plausible physical simulation that comports with a person's typical and expected experience of a given physical environment. Furthermore, it can achieve this even with low and variable bandwidth between users, or users and a central communication server.

### CROSS REFERENCE TO RELATED APPLICATIONS

This application claims benefit to U.S. Provisional Application No. 62/516,573, filed Jun. 7, 2017, entitled “MULTIPARTY COLLABORATIVE INTERACTION IN A VIRTUAL REALITY ENVIRONMENT,” the contents of which are hereby incorporated by reference in their entirety.

### BACKGROUND

### Technical Field

This disclosure relates to Virtual Reality (VR) systems and collaborative actions within simulated environments. More specifically, this disclosure relates to systems and methods for real-time collaborative concurrent manipulation of physicalized objects in virtual reality by a plurality of networked users.

### Related Art

VR replicates real and imaginary environments and simulates the user's physical presence in those environments. This is achieved using a combination of hardware and software that renders visual, audial, and tactile feedback based on user movements. In basic VR environments, this input can be through simple devices, such as a mouse, keyboard or gaming controller. More advanced VR environments will track the physical motion of the user, using sensors placed on the user, treadmills, or by analyzing real-time video of the user, or a combination of them all. The visual and audial rendering can be presented via a headset, Head Mounted Display (HMD), worn by the user, although any mechanism that presents user localized audio and video could be used. Tactile or haptic feedback can be given by a plethora of control devices, including but not limited to, hand held controllers with rumble motors, gloves, full and partial-body suits, chairs, controlled air flows and immersive smart-fluids. In addition, some environments supply smell and taste based sensory feedback.

VR environments can be used for immersive, mostly passive, presentation, such as films, documentaries, concerts, sports broadcasts and art exhibits. They can also be used for interactive video games, design, engineering and planning applications, therapeutic treatments, remote tele-presence and for education and training.

Real time collaborative software environments allow disparate people to interactively work together. Examples of these are group calls with shared screens, shared editable documents, and multiplayer gaming.

There are many terms used in the current literature to describe VR and related areas, such as Augmented Reality (AR) and Mixed Reality (MR). The blanket abbreviation X Reality (XR) is often used. XR is a simplified term that can refer to any type of digital reality, including but not limited to mixed reality, virtual reality, and augmented reality. XR covers the whole virtual reality continuum and any combinations of realities.

### SUMMARY

In general, this disclosure describes systems and methods related to devices, systems, and methods for collaborative manipulation of one or more virtual objects by a plurality of users within a virtual reality environment.

One aspect of the disclosure provides a non-transitory computer-readable medium including instructions that when executed on one or more processors, cause a computing device to simulate real-time interaction for a plurality of users in a networked virtual reality environment, the plurality of users cooperatively manipulating one or more virtual object representations, the plurality of user being located at physically disjoint locations. The instructions can cause the computing device to provide gesture-based gross and fine control of the one or more virtual object representations within the said virtual reality environment to the plurality of users. The instructions can cause the computing device to supply multiple points of concurrent access to the one or more virtual object representations within the virtual reality environment to a first user of the plurality of users. The instructions can cause the computing device to create a visual representation of manipulations and interactions with the one or more virtual object representations on a display of the computing device, provide audio feedback of the manipulations and interactions on an audio renderer of the computing device, and provide tactile feedback of the manipulations and interactions to the first user. The instructions can cause the computing device to transmit digital representations of the manipulations and interactions of the first user via a network medium to one or more other computing devices to allow users associated with the one or more other computing devices to experience and control the virtual reality environment in synchrony on multiple suitable devices and embodiments.

Another aspect of the disclosure provides a method for enabling collaborative action in a virtual reality environment. The method can include simulating, by one or more processors, a real-time interaction for a plurality of users in a networked virtual reality environment, the plurality of users cooperatively manipulating one or more virtual object representations, the plurality of user being located at physically disjoint locations. The method can include providing, by the one or more processors, gesture-based gross and fine control of the one or more virtual object representations within the said virtual reality environment to the plurality of users. The method can include supplying, by the one or more processors within the virtual reality environment, multiple points of concurrent access to the one or more virtual object representations within the virtual reality environment to a first user of the plurality of users. The method can include creating, by the one or more processors on a display, a visual representation of manipulations and interactions with the one or more virtual object representations. The method can include providing, by the one or more processors, audio feedback of the manipulations and interactions on an audio renderer. The method can include providing, by the one or more processors via an output device, tactile feedback of the manipulations and interactions to the first user. The method can include transmitting digital representations of the manipulations and interactions of the first user via a network medium to one or more other computing devices to allow users associated with the one or more other computing devices to experience and control the virtual reality environment in synchrony on multiple suitable devices and embodiments.

Other features and advantages of the present disclosure should be apparent from the following description which illustrates, by way of example, aspects of the disclosure.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 is a flowchart of an embodiment of a method for multiparty collaborative interaction in a virtual reality environment;

FIG. 2 is a flowchart of an embodiment of a method for grasp point determination of FIG. 1;

FIG. 3 is a flowchart of an embodiment of a method for blended animation construction;

FIG. 4 is a flowchart of an embodiment of a method for client event processing;

FIG. 5 is a graphical representation of an embodiment of a system for use with the methods of FIG. 1, FIG. 2, FIG. 3, and FIG. 4; and

FIG. 6 is a functional block diagram of a device for use in the execution of the methods of FIG. 1, FIG. 2, FIG., 3 and FIG. 4 and in the system of FIG. 5.

### DETAILED DESCRIPTION

The detailed description set forth below is intended as a description of various embodiments and is not intended to represent the only embodiments in which the disclosure may be practiced. The detailed description includes specific details for the purpose of providing a thorough understanding of the embodiments. In some instances, well-known structures and components are shown in simplified form for brevity of description.

This disclosure describes true interaction between a plurality of users in real-time, where virtual physicalized objects (e.g., virtual object representations) can be handed around among users, jointly lifted, carried and placed, while maintaining a smooth continuity of experience and plausible physical simulation that comports with a person's typical and expected experience of a given physical environment. Furthermore, it can achieve this even with low and variable bandwidth between users, or users and a central communication server.

This is attained with a combination of multiple technologies, including embedded grasp point information on objects, dynamic grasp point generation, embedded physical object parameters, a rigid-body physical simulation system with support for joint constraints, event-based network communication, virtual avatar telepresence simulation, and context-aware blended procedural animations. A joint constraint places restrictions on the positional and rotational relationship between two points on two otherwise independent physical objects. This can be used without limitation to the foregoing example to limit the range of separation and degrees of rotational freedom between two objects, such as bones in an animation skeleton. Soft joint constraints allow for some margin of error in the resolution of constraint systems and may be implemented in many ways, not limited to Baumgarte stabilization, simulated spring dampening or custom function mapping.

Oriented grasp points, as used herein, are embedded in virtual objects that can be interacted with. When a virtual avatar hand is within the embedded grasp range of an unoccupied grasp point, and a correctly oriented grasp gesture is made with the virtual avatar hand, the disclosed system provides a context appropriate pre-authored animation from a library of animations for the virtual avatar hand, and blends it with a calculated procedural animation of a kinematic chain connecting the avatar hand to the grasp point.

Without limitation on the extent of the geometric analysis, grasp points can also be dynamically generated with queries from the avatar representation against the stored shape of virtual objects within grasp range. As used herein, virtual objects or virtual object representations can include or be embedded with data representing one or more physical characteristics and properties of real world allegories of these virtual objects.

This event, and the time of the event, but not any of the animation events, can be communicated to all the viewers of the object and avatars, either directly via a peer-to-peer network connection, or indirectly through a central communication server.

At this stage the hand is now attached to the grasp point, and is considered part of a jointed animated simulation island, comprising the hand, the grasped object, and any other hands (e.g., of other avatars) attached to the object.

Each virtual hand has a maximum force that it can apply to the object simulation island. An object simulation island can be constructed by recursively accumulating all dynamic objects that are in contact with each other, and consists of those mutually connected objects and any immovable objects that they rest against. An avatar or avatar proxy becomes part of the simulation island when it contacts any dynamic object in the simulation island. Simulation islands are persistent data structures that change when dynamic objects come into contact with or separate from the dynamic objects that constitute an island. Each island is by definition separate from every other island, and physical system solvers can operate on them independently. While in the simulation, this will help determine the actual placement and visualization of the hand and object, and communicate a sense of weight to the users. The perceived movement of the whole avatar, and the hands, are constrained by these connections.

In this manner, an object can be robustly passed from hand to hand with multiple users.

A plurality of users can simultaneously interact with an object if they have access to an available grasp point. Thus, multiple grasp points on any virtual or authored object can provide (e.g., to a virtual character or actor) multiple points of concurrent access to the virtual or authored object within a XR environment. The simulation progresses locally for each user. In one version of the embodiment only accumulated force application events from avatar movement, attachment events and detachment events are being communicated among the participants. In an embodiment, the force events are not broadcast, only the position and orientation of the participating avatars is sent. The simulation itself is never directly communicated among users. There is no limit on the number of potential grasp points whether they are pre-authored or dynamically generated. In an embodiment, users may not be able to simultaneously select the same grasp point, or a grasp point that is blocked by another avatar or environmental object.

Grasp events, release events, and external force events, such as are caused by other users or parts of the world simulation interacting with the object, will cause local haptic feedback to the user.

In this way, a group of users may collaboratively manipulate a bulky or heavy virtual object that they could not manipulate alone.

Locally, to the client CPU of each connected user, the simulation can smooth events, especially those that occurred before the current simulation time and cause simulation rollback on their arrival to hide any discontinuities caused by network communication lag.

The systems disclosed herein can simulate real-time interaction for a plurality of physically disjoint users in a networked virtual reality environment, cooperatively manipulating physicalized virtual object representations, provide gesture-based gross and fine control of authored objects within the said virtual reality environment, and supply multiple points of concurrent access to authored objects within the environment and create a visual representation of said manipulations and interactions. The manipulations and interactions can be projected on a display for the user. The system can further provide audio feedback of those manipulations and interactions provide tactile feedback of those manipulations and interactions through suitably connected controllers or other devices, without limitation, in contact or providing contact to the user.

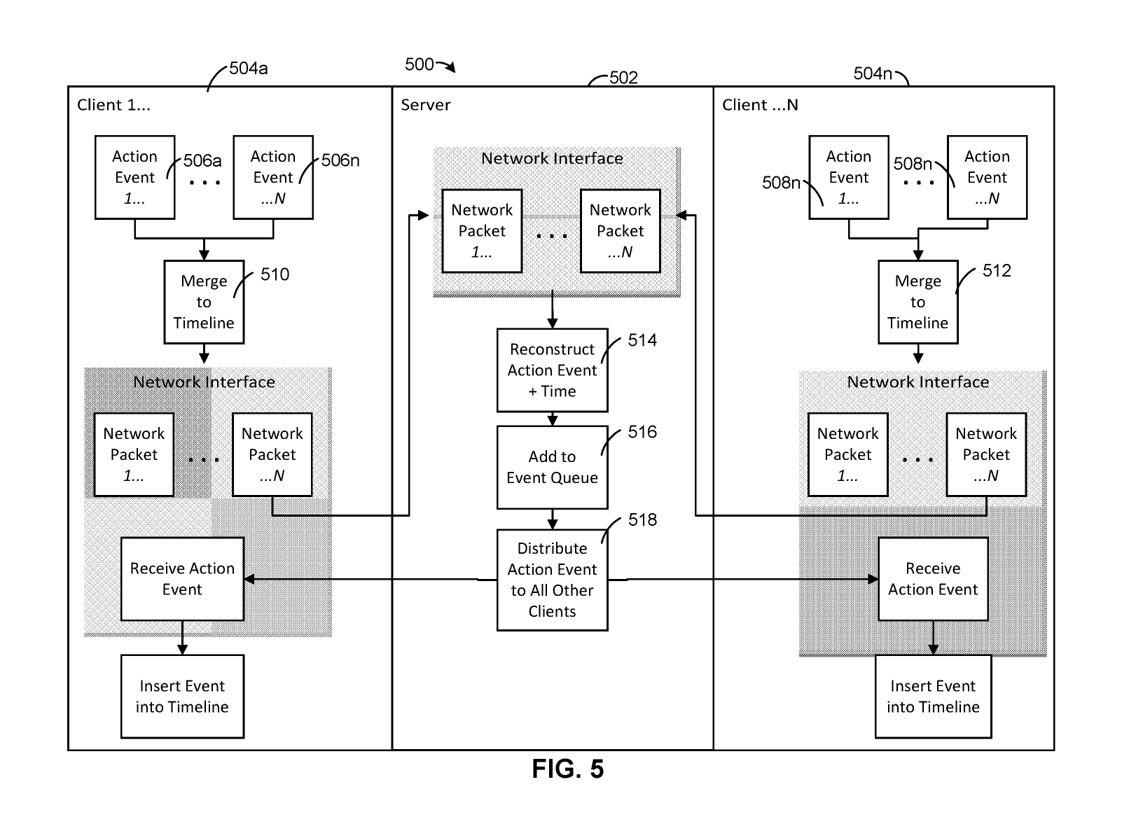

In some embodiments, the system can further transmit all manipulations and interactions through any suitable network medium so that a plurality of users can experience and control the virtual reality environment in synchrony on multiple suitable devices and embodiments. See below description of FIG. 5.

The system can provide a plurality of attached representations of oriented grip points on virtual objects, and records of whether those points are, at any time during execution, currently gripped by a user, blocked by the virtual avatar representation of the user, or blocked by other virtual objects in the world from access to any given oriented user avatar.

The system can provide a plurality of virtual object representations with embedded data representing the physical characteristics and properties of real world allegories of these virtual objects.

The system can perform a procedural physical simulation embodying the physical properties, characteristics and dimensions of the virtual objects such that virtual contact of those objects with each other proceeds in a manner consistent with the real-world observation of similar objects interacting with each other.

The system can provide temporal and consistent contacts between virtual objects are represented without limitation as joint constraints with authorable degrees of freedom of movement in rotation and translation and as penetration constraints between temporally maintained contact patch geometrical representations.

The system can simulate non-moveable objects as being of infinite mass. Such objects can be end-points of simulation islands, such as would be understood by those conversant in the art.

The system can simulate all collections of virtualized objects joined by contacts, separately from other collections of virtualized objects that do not share common constraints other than those on the simulation end-points.

The system can receive a notification of a physical event at a time prior to the current time, rewind the simulation to that previous time to insert the physical event, and then progress forward to the current time of the simulation.

The system can provide/render full and partial avatar representations of local and external parties with local constraints, grasping objects and other avatar representations, so that collaborative interaction occurs with other users.

The system can blend the local representations of avatars and objects from their true positions and orientations, as determined by the physical simulation based on transmitted events, towards an expected set of positions and orientations based on temporal persistence such that movement is perceived as natural and free of jarring and pops.

The system can implement one or more multichain inverse kinematic solvers to determine ideal positioning of attached grips and chained animation skeletons based on positions and orientations of avatars and objects.

The system can store a library of preexisting hand-authored, motion-captured, or procedurally generated animations and search the library for animations that match the ideal positioning of attached grips and chained animation skeletons. The selected animations can be blended towards the ideal positioning. The animation can be blended from the previous displayed animation to avoid popping. Changes in the position and orientation of the avatars can be sampled and transmitted as messages on any appropriate network medium or communication bus.

The system can transmit discrete events of, for example, grip, release, pull, push, punch, select, and any other changes in context of the virtualized object that can be transmitted between users as messages on any appropriate network medium or communication bus.

The system can cause each user of a plurality of users to receive the networked messages regarding changes to the state of each associated avatar, update local persistent states for each avatar and derive an ideal position, orientation, and animated representation based on the networked messages.

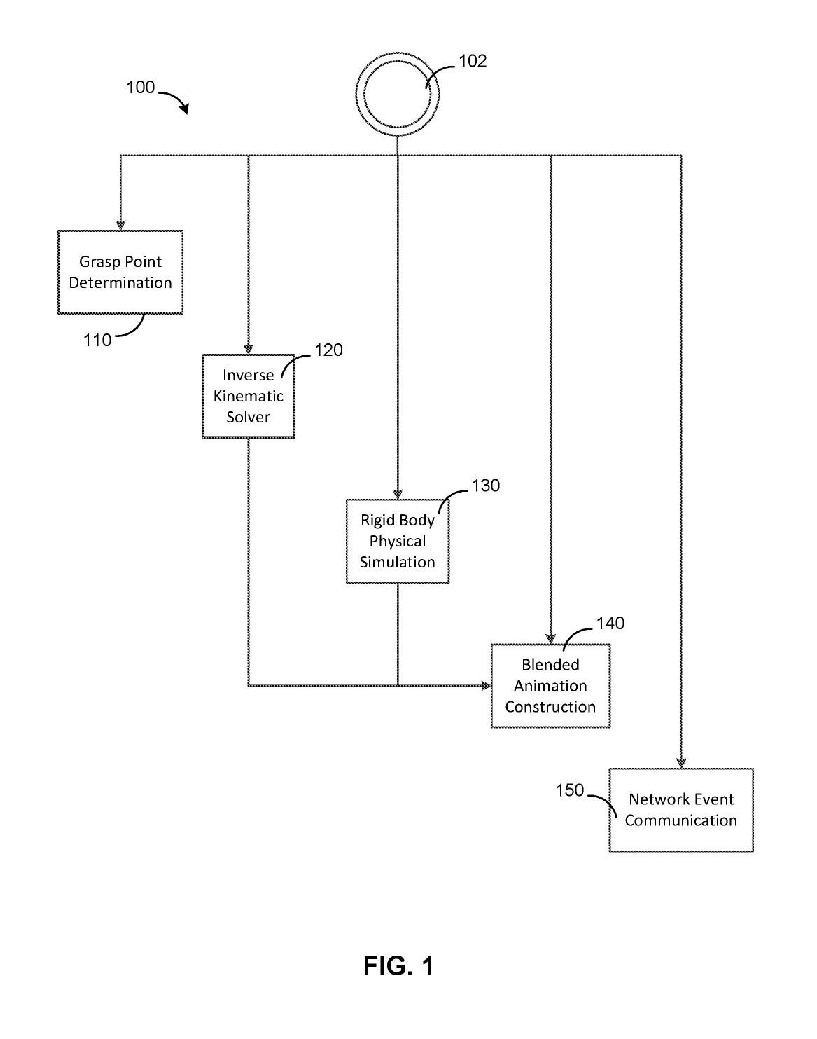

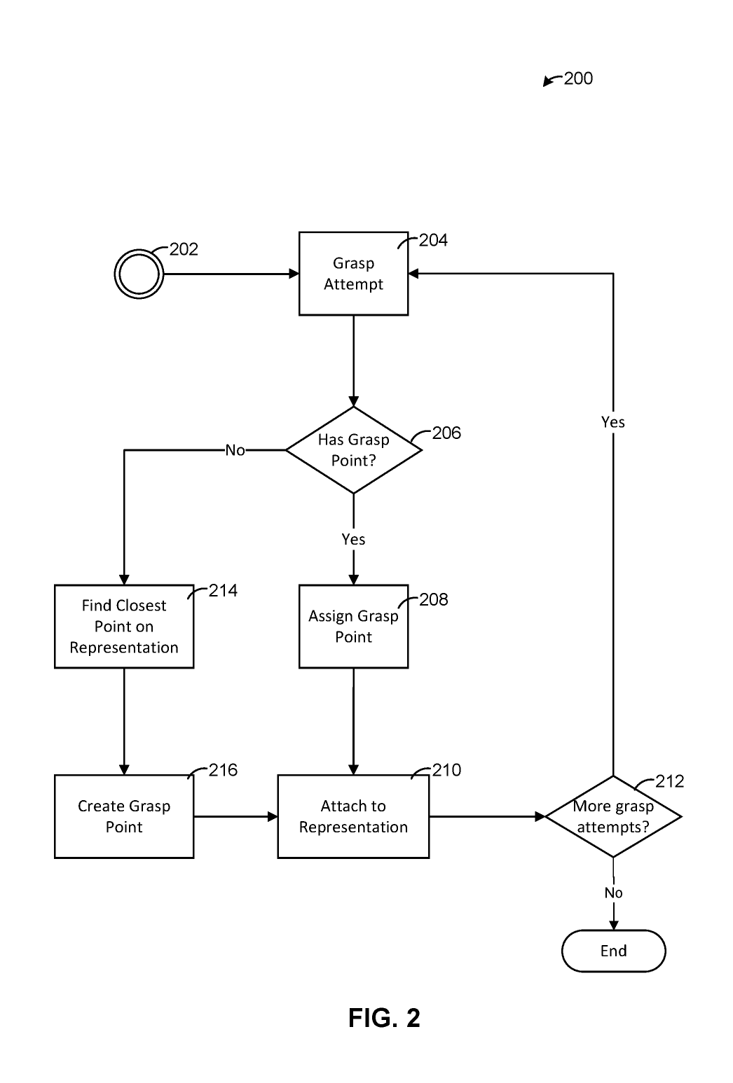

FIG. 1 is a flowchart of an embodiment of a method for multiparty collaborative interaction in a virtual reality environment. In some embodiments, a method 100 can have five primary steps or components. The method 100 can start at block 102. At block 110, one or more grasp points on a virtual object can be determined (Grasp Point Determination) as described in more detail in connection with FIG. 2. At block 120, the system can implement an Inverse Kinematic Solver to determine plausible one or more arrangements of a given avatar such that it attaches to the grip point. At block 130 the system can implement a Rigid Body Physical Simulation. The Rigid Body Simulation implements constraints to prevent penetrative collision between the avatar and, for example, the virtual object or other avatars. The Rigid Body Physical Simulation can aid in maintaining a realistic XR simulation. At block 140, the method can include a Blended Animation Construction. The blended animation construction can take inputs from the inverse kinematic solver and the rigid body simulation and to generate a final animation pose for each avatar. At block 150, the method can include Network Event Communication and Management governing how a plurality of clients (e.g., client 1 through client N), coupled to a server, communicates and interact (see FIG. 5).

### Grasp Point Determination

FIG. 2 is a flowchart of an embodiment of a method for grasp point determination of FIG. 1. A method 200 depicts the flow of the determination of one or more grasp points on a virtual object (e.g., block 110). Oriented grasp point hints may be embedded as metadata in the description of the virtual object. These hints can be simple tagged geometry, such as a discrete lines, cylinders, points, vectors, planes or bases, or more sophisticated representations that suggest appropriate animations for interacting with them. All grasp points can have implicit or explicit bounds that allow the application to determine relative proximity.

In an embodiment, not all objects may necessarily have embedded grasp hints, and for those objects query rays are extended from the virtual hands against the virtual geometry of the object; this geometry can represent the visual rendering of the object or an underlying collision geometry used by a rigid body collision simulation. The results of the queries will give a surface and, optionally, an orientation for the hands to attach to the object. This will be the default behavior for simple convex rigid objects. Pre-authored grasp points with animation suggestions can be used for more complex object interactions, such as hand to hand, or hand to non-convex rigid objects or hand to animated objects.

At block 204 a first avatar can make a grasp attempt on a virtual object. At decision block 206, the system the system queries a local data representation of the virtual object to determine if the object has one or more embedded grasp points. If yes, then the method 200 can proceed to block 208 where the system can assign a grasp point. The virtual object may have a plurality of grasp points as needed or designed.

At block 210, the avatar can attach to the representation of the virtual object being grasped at the grasp point and, for example, manipulate the virtual object.

At decision block 212, the system can determine if there are other grasp attempts on the virtual object. If so, then the method 200 can return to block 204. If no further grasp attempts are made, the method 200 can end. In some examples, the system can periodically check for new grasp attempts (e.g., block 204) as needed.

If at decision block 206, the virtual object does not have a grasp point, at block 214, the system can determine a closest point on the representation of the virtual object to the gripping manipulator of the avatar.

At block 216, the system can create a grasp point as needed. The created grasp point can be a temporary grasp point data representation on the virtual object. The temporary grasp point can then have the position and orientation determined in block 214. Once the new grasp point has been created, the method 200 can proceed back to block 210.

### Inverse Kinematic Solver

The Inverse Kinematic Solver at block 120 (FIG. 1) determines a plausible arrangement of the avatar animation rig such that it attaches to the grip point. Some solvers such as Featherstone's Algorithm can be used for this; but for stability it is recommended that a fixed iterative solver (potentially but not limited to Projected Gauss-Seidal) is used with Baumgarte Stabilization to correct for positional joint drift. The solver must return a consistent result when no solution can be found. Accordingly, the disclosed system can prevent additional energy being added into the system, and any energy changes are propagated into subsequent solver steps.

A variation of the rigid body physical simulation solver may also be used to derive a solution for the connected kinematic chain.

The solver can function on the client-side only, and can use object positions that have been blended from the previous time-step with an appropriate filter to hide large discontinuities in position and orientation. In an embodiment, no blending occurs when the discontinuities are small.

The output of the solver is passed to the Blended Animation Construction phase.

### Rigid Body Physical Simulation

It is expected that any suitable, stable, rigid body physical simulation may be used (e.g., block 130 of FIG. 1). At a minimum, the rigid body physical simulation supports calculating constraints to prevent penetrative collision, maintaining joint constraints with arbitrary limits on separation and rotation, stable stacking, and consistent friction simulation.

The simulation must support rewinding to a fixed time and replaying all simulation events when new events are received that are earlier than the current simulation time. Such simulation rewinding may be limited to the localized islands in which the event takes place.

Constraints can be added to the system when objects are grasped, and removed when they are released. Impulses may also be applied to simulate forces acting on the grasped objects, when the users pull, push, shake or throw them.

The results of the rigid body simulation may be passed to the Blended Animation Construction phase, where the actual displayed positions and orientations of the objects may be blended from previous positions and orientations.

### Blended Animation Construction

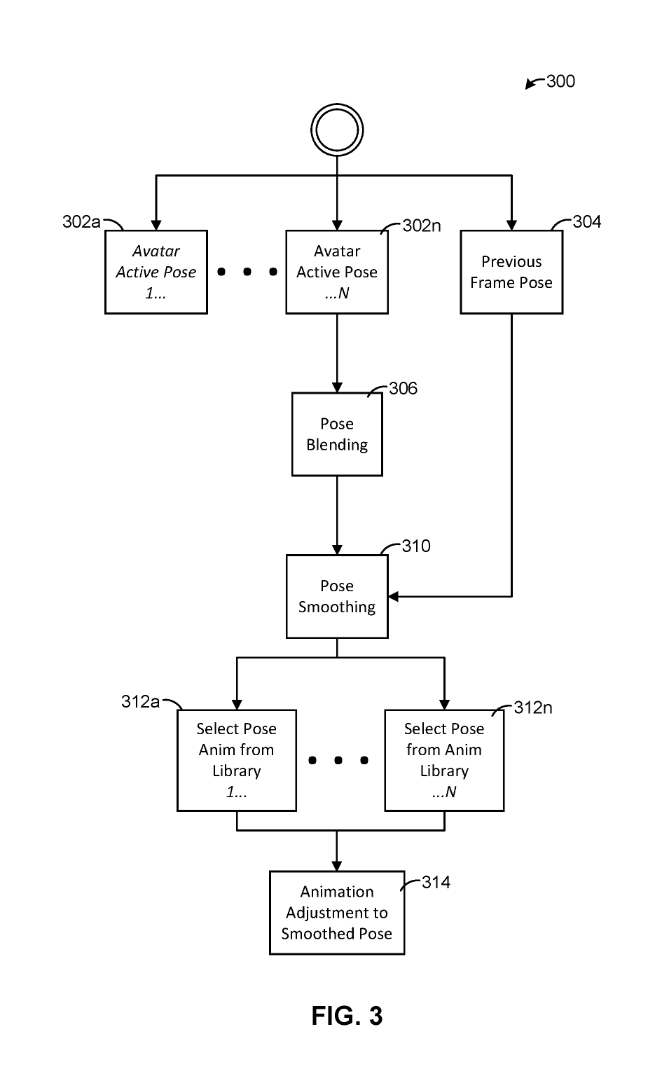

FIG. 3 is a flowchart of an embodiment of a method for blended animation construction. A method 300 can be used to generate a final animation pose for each avatar as in block 140 (FIG. 1). The method 300 can first consider a plurality of avatar poses (avatar poses 1-N) in blocks 302a, 302n and a previous frame pose at block 304. The generation of the final animation pose for each avatar can have of four phases in the ideal implementation, including: 1) Pose Blending (block 306); 2) Pose Smoothing (block 310); 3) Animation Selection from Smoothed Pose (blocks 312a, 312n); and 4) Animation Adjustment to Match Smoothed Pose (block 314).

1. The input target pose from the Inverse Kinematic Solver at block 120 may be blended with all active poses of blocks 302a, 302n for the avatar's state, as an example, but not limited to, walking, crouching, and leaning motions, and with general avatar orientation poses, such as for head turning.

2. The resultant pose can be optionally blended at block 206 with the pose generated by the previous time step to hide any remaining discontinuities in movement. In some cases, no blending may occur if the difference is small.

3. At block 312a, 312n, the resultant pose can then be used to find and select pre-authored or motion-captured poses in a library of poses that closely match it. Suitable weights are generated to blend between the matched poses and the target animation pose. These poses can have additional animation hierarchies supporting secondary motion that are not represented by the input pose.

4. At block 314, the resultant weighted animation can be fitted to the target pose of phase 2 to yield the final display animation for the avatar.

### Network Event Communication and Management

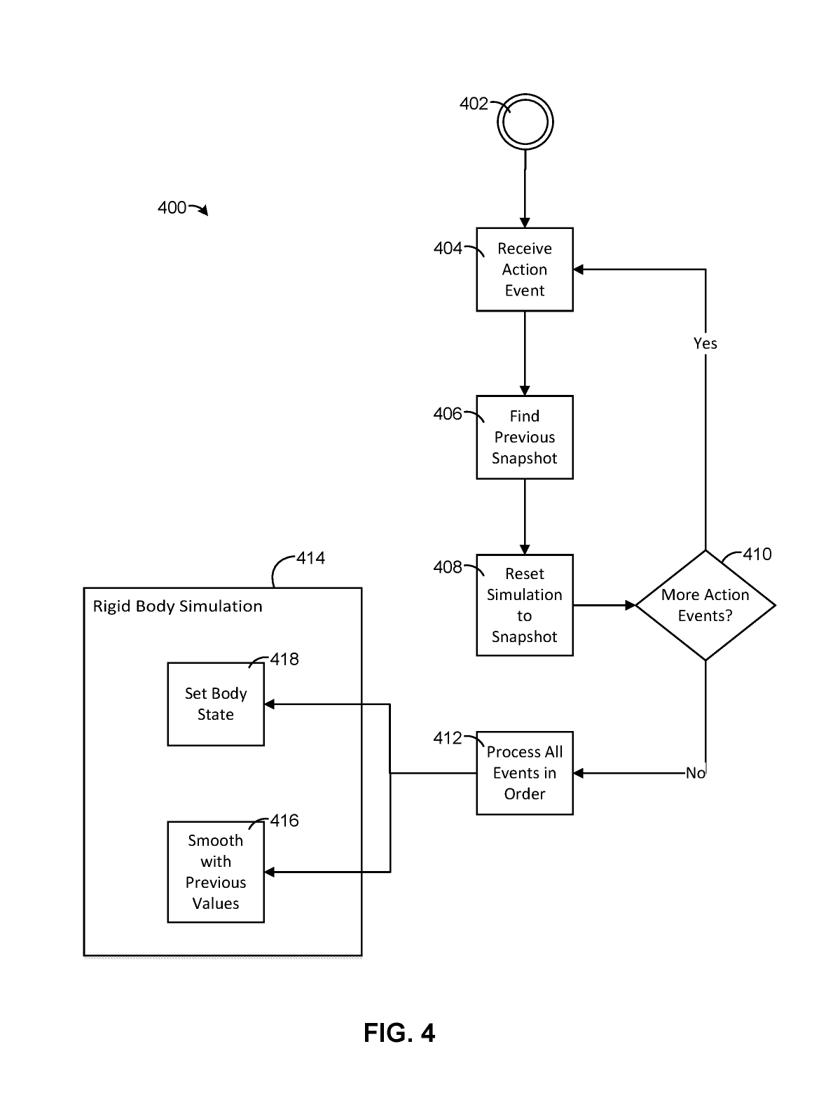

FIG. 4 is a flowchart of an embodiment of a method for client event processing. Each avatar action and change in context, such as, but not limited to, grip, release, pull, push, punch, select, is sent as a discrete event with a world simulation time from each local client to all peers that can view the avatar, either directly or via a central networking server, or another suitable intermediary network broadcasting device.

Changes in positions and orientations of key avatar parts, such as, but not limited to, hands, head and root bones are communicated as discrete events, and may be sampled on fixed time-steps to reduce network transmission cost.

Each client maintains a state of each avatar, as it understands it. It also maintains a state representing the world physical simulation that can be represented by a rigid-body physical simulation as described. There may be multiple records of these states at different simulation times. Each state stored this way records the event at which it was generated.

A method 400 can begin with block 402. At block 404 a client can receive an action event. Action events can be generated by local and/or remote avatar inputs. Action events can be mediated through a network messaging layer similar to that described below in connection with FIG. 5. Each action event can have a fixed world simulation time associated with it. When an event is received by a client, that event is stored in an event queue sorted by time. At block 406, the system can find a previous snapshot that occurred prior to the action event received at block 402.

At block 408 and the start of the simulation step, if any new events were received that were earlier than the events recorded for specific states then all later state records are discarded and the simulation reset. If more action events are received at decision block 410, the method 400 can return to block 402. All subsequent events from the last viable state record are then replayed in order (block 412), to generate new states which accommodate the new information.

At block 414, within the rigid body simulation (e.g., block 130 of FIG. 1) the method 400 can include setting the avatar body state (block 418) and smoothing the simulation (e.g., block 416) with previous values. The positions and orientations of all objects and avatars are recorded from the last time step, so that gross errors caused by unreliable network communication can be smoothed out.

FIG. 5 is a graphical representation of an embodiment of a system for use with the methods of FIG. 1, FIG. 2, FIG. 3, and FIG. 4. A system 500 can have a server 502 coupling a plurality of clients 504 (e.g., client 1 through client N, where N is an integer). The clients 504 are labeled as client 504a and 504n. The server 502 can have a central processing unit (CPU) having one or more processors or microprocessors operable to execute the steps of the foregoing methods 100, 200, 300, 400, for example. The server 502 can also have a network interface operable to communicatively couple client 1 504a to the client N 504n in a virtual (e.g., XR) environment.

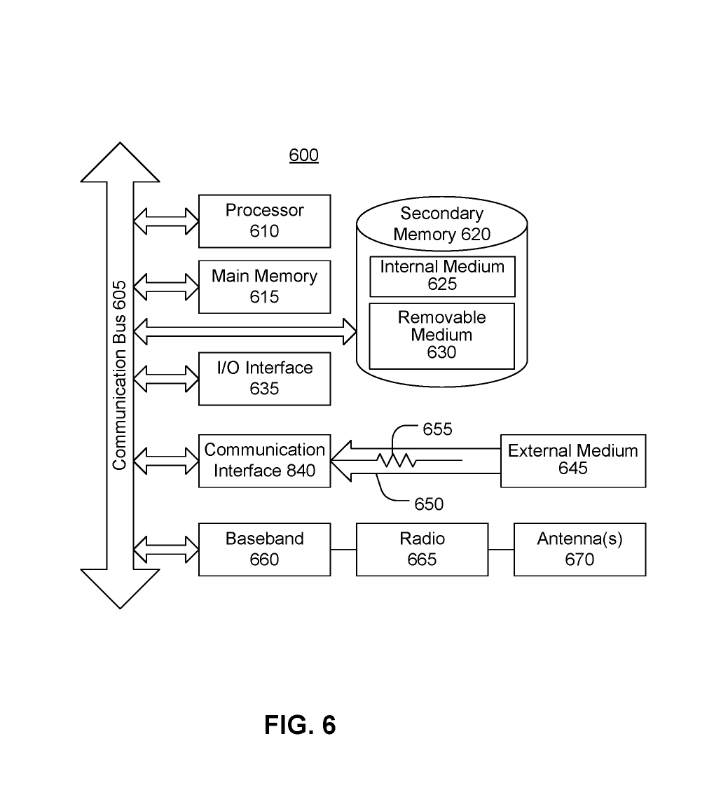

The server 502 can also have one or more memories coupled to the CPU, for example, to store information and instructions related to the method described above (e.g., the methods 100, 200, 300, 400). The system of described below in FIG. 6 can also be implemented in the construct of FIG. 5 to execute the methods described herein.

The system 500 can couple the various clients 504 in an XR environment to jointly manipulate a virtual object. Each of the clients 504 can be associated with a timeline. A timeline is an array of all action events known to a given client 504. In some embodiments, the timeline can reference (or include) a series of action events of an avatar associated with one of the clients 504. The action events can occur as a series or timeline of avatar actions. For example, the client 504a can have a first plurality of action events 506a-506n that can be merged to a first timeline at block 510. Similarly, the second client 504n can have a second plurality of action events 508a-508n that can be merged into a second timeline at block 512. The first timeline and the second timeline can be shared over a network with the server 502. The server can then reconstruct (block 514) the action events of the clients 504 into a single stream (block 516) according to the first timeline and the second timeline. The action events can be simultaneously shared or distributed (block 518) among the clients 504. Then, for example, the first client 504a can merge the second timeline from the second client 504n with the first timeline. Similarly, the second client 504n can merge the first timeline from the first client 504a with the second timeline. This can allow the clients 504 to interact within the XR environment.

FIG. 6 is a functional block diagram of a device for use in the execution of the methods of FIG. 1, FIG. 2, FIG., 3 and FIG. 4 and in the system of FIG. 5. An exemplary system 600 may be used in connection with various embodiments described in connection with FIG. 1 through FIG. 4. For example system 600 may be used as or in conjunction with one or more of the server 502, the clients 504, and/or other devices described herein for use in XR environments. The system 600 can be a processor-enabled device that is capable of wired or wireless data communication. Other computer systems and/or architectures may be also used, as will be clear to those skilled in the art.

The system 600 can have one or more processors, such as processor 610. The processor 610 can perform, in whole or in part, the methods described in connection with the flowcharts in FIG. 1, FIG. 2, FIG. 3, and FIG. 4. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 610.

Processor 610 can be coupled to a communication bus 605. Communication bus 605 may include a data channel for facilitating information transfer between storage and other peripheral components of system 600. Furthermore, communication bus 605 may provide a set of signals used for communication with processor 610, including a data bus, address bus, and control bus (not shown). Communication bus 605 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 600 can have a main memory 615 and may also include a secondary memory 620. Main memory 615 provides storage of instructions and data for programs executing on processor 610, such as one or more of the functions and/or modules discussed above. It should be understood that programs stored in the memory and executed by processor 610 may be written and/or compiled according to any suitable language, including without limitation C/C++, Java, JavaScript, Perl, Visual Basic, .NET, and the like. Main memory 615 can be a semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 620 may optionally include an internal memory 625 and/or a removable medium 630. Removable medium 630 is read from and/or written to in any well-known manner. Removable storage medium 630 may be, for example, a magnetic tape drive, a compact disc (CD) drive, a digital versatile disc (DVD) drive, other optical drive, a flash memory drive, etc.

Removable storage medium 630 is a non-transitory computer-readable medium having stored thereon computer-executable code (e.g., disclosed software modules) and/or data. The computer software or data stored on removable storage medium 630 is read into system 600 for execution by processor 610.

In alternative embodiments, secondary memory 620 can include other similar means for allowing computer programs or other data or instructions to be loaded into system 600. Such means may include, for example, an external storage medium 645 and a communication interface 640, which allows software and data to be transferred from external storage medium 645 to system 600. Examples of external storage medium 645 may include an external hard disk drive, an external optical drive, an external magneto-optical drive, etc. Other examples of secondary memory 620 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, the system 600 may include a communication interface 640. Communication interface 640 allows software and data to be transferred between the system 600 and external devices such as the relay nodes (e.g. another system 600), networks, or other information sources. For example, data, computer software, or executable code may be transferred to System 600 from a network server via communication interface 640. Examples of communication interface 640 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing the system 600 with a network or another computing device. The communication interface 640 preferably implements industry-promulgated protocol standards, such as IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 640 are generally in the form of electrical communication signals 655. These signals 655 may be provided to communication interface 640 via a communication channel 650. In an embodiment, communication channel 650 may be a wireless network, or any variety of other communication links. Communication channel 650 can carry the signals 655 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs, such as for the disclosed XR renderings and simulations or software modules) is stored in main memory 615 and/or the secondary memory 620. Computer programs can also be received via communication interface 640 and stored in main memory 615 and/or secondary memory 620. Such computer programs, when executed, enable system 600 to perform the various functions of the disclosed embodiments as described elsewhere herein.

In this description, the term “computer-readable medium” is used to refer to any non-transitory computer-readable storage media used to provide computer-executable code (e.g., software and computer programs) to system 600. Examples of such media include main memory 615, secondary memory 620 (including internal memory 625, removable medium 630, and external storage medium 645), and any peripheral device communicatively coupled with communication interface 640 (including a network information server or other network device). These non-transitory computer-readable mediums are means for providing executable code, programming instructions, and software to system 600.

In an embodiment that is implemented using software, the software may be stored on a computer-readable medium and loaded into system 600 by way of removable medium 630, I/O interface 635, or communication interface 640. In such an embodiment, the software is loaded into system 600 in the form of electrical communication signals 655. The software, when executed by processor 610, preferably causes processor 610 to perform the features and functions described elsewhere herein.

In an embodiment, I/O interface 635 provides an interface between one or more components of system 600 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

System 600 may also include optional wireless communication components that facilitate wireless communication over a voice network and/or a data network. The wireless communication components comprise an antenna system 670, a radio system 665, and a baseband system 660. In the system 600, radio frequency (RF) signals are transmitted and received over the air by antenna system 670 under the management of radio system 665.

In an embodiment, antenna system 670 can have one or more antennae and one or more multiplexors (not shown) that perform a switching function to provide antenna system 670 with one or more transmit and receive signal paths. The relay nodes described in connection with FIG. 2 through FIG. 9 can also have one or more antennae in their respective antenna systems 670.

In the receive path, received RF signals can be coupled from a multiplexor to a low noise amplifier (not shown) that amplifies the received RF signal and sends the amplified signal to radio system 665.

In an alternative embodiment, radio system 665 may comprise one or more radios that are configured to communicate over various frequencies. In an embodiment, radio system 665 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 665 to baseband system 660.

If the received signal contains audio information, then baseband system 660 decodes the signal and converts it to an analog signal. Then the signal is amplified and sent to a speaker. Baseband system 660 also receives analog audio signals from a microphone. These analog audio signals are converted to digital signals and encoded by baseband system 660. Baseband system 660 also codes the digital signals for transmission and generates a baseband transmit audio signal that is routed to the modulator portion of radio system 665. The modulator mixes the baseband transmit audio signal with an RF carrier signal generating an RF transmit signal that is routed to antenna system 670 and may pass through a power amplifier (not shown). The power amplifier amplifies the RF transmit signal and routes it to antenna system 670, where the signal is switched to the antenna port for transmission.

Baseband system 660 is also communicatively coupled with processor 610, which may be a central processing unit (CPU). Processor 610 has access to data storage areas 615 and 620. Processor 610 is preferably configured to execute instructions (i.e., computer programs, such as the disclosed application, or software modules) that can be stored in main memory 615 or secondary memory 620. Computer programs can also be received from baseband processor 660 and stored in main memory 615 or in secondary memory 620, or executed upon receipt. Such computer programs, when executed, enable System 600 to perform the various functions of the disclosed embodiments. For example, data storage areas 615 or 620 may include various software modules.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, and algorithm operations described in connection with the embodiments disclosed herein may be implemented as electronic hardware, computer software, or combinations of both. To clearly illustrate this interchangeability of hardware and software, various illustrative components, blocks, modules, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, and modules described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A non-transitory computer-readable medium including instructions that when executed on one or more processors, cause a computing device to:
simulate real-time interaction for a plurality of users in a networked virtual reality environment, the plurality of users cooperatively manipulating one or more virtual object representations, the plurality of user being located at physically disjoint locations;
provide gesture-based gross and fine control of the one or more virtual object representations within the said virtual reality environment to the plurality of users;
supply multiple points of concurrent access to the one or more virtual object representations within the virtual reality environment to a first user of the plurality of users;
create a visual representation of manipulations and interactions with the one or more virtual object representations on a display of the computing device, provide audio feedback of the manipulations and interactions on an audio renderer of the computing device, provide tactile feedback of the manipulations and interactions to the first user;
transmit digital representations of the manipulations and interactions of the first user via a network medium to one or more other computing devices to allow users associated with the one or more other computing devices to experience and control the virtual reality environment in synchrony on multiple suitable devices and embodiments.

2. The non-transitory computer-readable medium of claim 1, wherein the instructions further cause the computing device to:
provide a plurality of grip points on the one or more virtual object representations; and
record a location of each grip point of the plurality of grip points and whether the plurality of grip points is at least one of
currently gripped by a user,
blocked by the virtual avatar representation of the user, and
blocked by other virtual objects in the world from access to any given oriented user avatar.

3. The non-transitory computer-readable medium of claim 1, wherein the one or more virtual object representations comprises embedded data representing one or more physical characteristics and properties of real world allegories of the one or more virtual object representations.

4. The non-transitory computer-readable medium of claim 3, wherein the instructions further cause the computing device to perform a physical simulation of the one or more virtual object representations embodying the physical properties, characteristics, and dimensions of the one or more virtual object representations such that virtual contact of the one or more virtual object representations by the first user proceeds in a manner consistent with the real-world observation of similar objects.

5. The non-transitory computer-readable medium of claim 4, wherein temporal and consistent contacts between the first user and the one or more virtual object representations are represented as joint constraints with authorable degrees of freedom of movement in rotation and translation and as penetration constraints between temporally maintained contact patch geometrical representations.

6. The non-transitory computer-readable medium of claim 4, wherein the instructions further cause the computing device to simulate one or more non-moveable objects, the one or more non-moveable object being simulated as having infinite mass.

7. The non-transitory computer-readable medium of claim 5, wherein the instructions further cause the computing device to simulate the one or more virtual object representations that are joined by contacts, together and separately from other collections of virtualized objects that do not share common constraints other than those on the simulation end-points.

8. The non-transitory computer-readable medium of claim 4, wherein the instructions further cause the computing device to:
receive a notification of a physical event by one of the plurality of users at first time in history, before a current time;
rewind the simulation to time to the first time and insert the physical event; and
perform the simulation starting at the first time and moving forward to the current time of the simulation.

9. The non-transitory computer-readable medium of claim 4, wherein the instructions further cause the computing device to provide collaborative object grasping between the plurality of users by rendering full and partial avatar representations of the plurality of users.

10. The non-transitory computer-readable medium of claim 9, wherein local representation of avatars and objects are blended from true positions and orientations as determined by the physical simulation based on transmitted events, towards an expected set of positions and orientations based on temporal persistence such that movement is perceived as natural and free of jarring and pops.

11. The non-transitory computer-readable medium of claim 1, wherein an ideal positioning of attached grips and chained animation skeletons given the positions and orientations of avatars and objects are determined based on multichain inverse kinematic solvers.

12. The non-transitory computer-readable medium of claim 11, wherein the instructions further cause the computing device to:
store a library of preexisting hand-authored, motion-captured, or procedurally generated animations; and
searched the library for animations that match the ideal positioning of attached grips and chained animation skeletons.

13. The non-transitory computer-readable medium of claim 12, wherein the selected animations are blended towards the ideal positioning.

14. The non-transitory computer-readable medium of claim 13, wherein the animation is blended from the previous displayed animation to avoid popping.

15. The non-transitory computer-readable medium of claim 1, wherein the instructions further cause the computing device to:
sample changes in the position and orientation of the avatars associated with the plurality of users; and
transmit one or more messages to the plurality of users including information related to the sampled changes.

16. The non-transitory computer-readable medium of claim 1, wherein the instructions further cause the computing device to transmit as one or more messages, changes in context of the avatars including at least, grip, release, pull, push, punch, and select, to the plurality of users.

17. The non-transitory computer-readable medium of claim 16, wherein the instructions further cause the computing device to cause each user of the plurality of users to update a local persistent state for each avatar and derive an ideal position, orientation and animated representation based on the one or more messages.

18. A method for enabling collaborative action in a virtual reality environment comprising:
simulating, by one or more processors, a real-time interaction for a plurality of users in a networked virtual reality environment, the plurality of users cooperatively manipulating one or more virtual object representations, the plurality of user being located at physically disjoint locations;
providing, by the one or more processors, gesture-based gross and fine control of the one or more virtual object representations within the said virtual reality environment to the plurality of users;
supplying, by the one or more processors within the virtual reality environment, multiple points of concurrent access to the one or more virtual object representations within the virtual reality environment to a first user of the plurality of users;
creating, by the one or more processors on a display, a visual representation of manipulations and interactions with the one or more virtual object representations;
providing, by the one or more processors, audio feedback of the manipulations and interactions on an audio renderer;
providing, by the one or more processors via an output device, tactile feedback of the manipulations and interactions to the first user; and
transmitting digital representations of the manipulations and interactions of the first user via a network medium to one or more other computing devices to allow users associated with the one or more other computing devices to experience and control the virtual reality environment in synchrony on multiple suitable devices and embodiments.
